(19) United States
(12) Patent Application Publication
(10) Pub. No.: US 2005/0257393 A1
(43) Pub. Date: Nov. 24, 2005

(54) Flexible adhesive tape measure

(76) Inventors: Jeffrey L. Spanski, Weddington, NC (US); John C. Smith, Denver, NC (US); Derek J. Nash, Huntersville, NC (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/851,802

(22) Filed: May 21, 2004

(51) Int. Cl. G01B 3/10

(52) U.S. Cl. 33/758

(57) ABSTRACT

A tape measure is formed of a flexible substrate having one or more scales with regularly spaced markings thereon and an adhesive disposed on at least one side thereof to allow the flexible substrate to be temporarily fixed to a surface, such as to a wall. This tape measure may be affixed to a surface to be measured and left in position while other activities take place, such as drilling holes, hanging pictures, etc. The flexible substrate is made of a material that easily accepts writing or marks from conventional pens or pencils to enable a user to mark a particular location on the tape measure substrate when the substrate is attached to the surface being measured without marking the surface itself. Later, if desired, the tape measure substrate, with the markings thereon, may be removed and disposed of. This tape measure is easy to use, because it can be fixed to a surface to be measured and stays in place while the user performs other steps, such as marking, drilling, nailing, etc. without the need for the user to hold the tape measure.

### BACKGROUND OF THE INVENTION

1. Field of the Disclosure

The present disclosure is generally directed to tape measures, and more particularly to flexible or disposable adhesive tape measures.

2. Description of Related Art

Various types of tape measure products are known in the art. Tape measures typically include a bendable substrate made of metal or cloth having one or more scales thereon, the scales including marks spaced at regular and fixed locations on the substrate, such as at every quarter, eighth, or sixteenth of an inch. In some products, the substrate is disposed on a roll such that the substrate may be unrolled or extended for use and rolled back up for storage.

Tape measures are used in many situations to make precise measurements, such as to make measurements in the building trades, to measure walls, ceilings, floors, etc. in the process of hanging pictures, artwork, cabinets, etc., to measure furniture or other stationary items, or to make measurements in numerous other situations which require precise measurements of large objects or distances. Generally speaking, these tape measures are unrolled and are held up against the surface being measured while a user marks locations on the surface at which holes are to be drilled, nails are to be inserted, etc.

However, it is sometimes difficult or cumbersome to use known tape measures. For example, a tape measure can be difficult to hold against a surface being measured, especially in cases in which the tape measure must be held up against a very long surface or in which the tape measure must be held for a long period of time. It is also difficult to use standard tape measures when measuring ceilings and other surfaces which do not support the tape measure substrate during the measuring process. Likewise, while some tape measures include an extension on the end thereof to enable the tape measure to “hold” onto an edge, there are many situations in which there is no edge on which the extension can be used, making it necessary to manually hold both ends of the tape measure against the surface being measured. Additionally, known tape measures are sometimes difficult to hold in position while a mark is being made on a surface being measured. In fact, it sometimes requires two or more hands to hold the tape measure substrate against the surface being measured and another hand to make the mark, thereby requiring more than one person to perform the measuring and marking procedure.

There are also many situations in which a user does not wish to make or leave a mark on the surface that is being measured, but has no choice because, the user needs to put down the tape measure and pick up another tool or object to be used at the precisely marked location. Moreover, it is sometimes desirable to measure irregular surfaces, such as around corners, etc., which is difficult to do using known tape measures, especially metal tape measures which are not typically capable of bending at angles with small radiuses of curvature, such as at right angles. It is also particularly difficult to make precise measurements on irregular or curved surfaces having large radiuses of curvature because known tape measure substrates do not follow irregular surfaces very well.

### BRIEF DESCRIPTION OF THE DRAWINGS

Objects, features, and advantages of the present invention will become apparent upon reading the following description in conjunction with the drawing figures, in which:

FIG. 1 is a perspective view of a flexible, adhesive tape measure partially disposed on and affixed to a surface;

FIG. 2 is a side view of a portion of a flexible, adhesive tape measure such as that of FIG. 1;

FIG. 3 is a top view of the flexible, adhesive tape measure of FIG. 2; and

FIG. 4 is a perspective view of a flexible, adhesive tape measure formed into a continuous roll.

### DETAILED DESCRIPTION OF THE DISCLOSURE

A tape measure is formed of a flexible substrate having at least one scale with regularly spaced markings thereon and an adhesive disposed on at least one side thereof to allow the flexible substrate to be temporarily or permanently affixed to a surface, such as to a wall. The flexible tape measure may be affixed to a surface to be measured and left in position while other activities take place, such as drilling holes, hanging pictures, hanging cabinets, etc. The flexible substrate is preferably made of a material, such as a paper material, that is easily torn, ripped or cut and that accepts writing or marks from conventional pens or pencils to enable a user to mark a particular location on the tape measure substrate when the substrate is attached to the surface being measured. Later, if desired, the tape measure, with the markings thereon, may be removed and disposed of. This tape measure has the advantage of being easy to use, because it can be fixed to a surface to be measured and stays in place while the user performs other steps, such as marking, drilling, nailing, etc. without the need for the user to hold the tape measure. This tape measure also enables a user to mark locations associated with a surface being measured, without making marks on the surface itself.

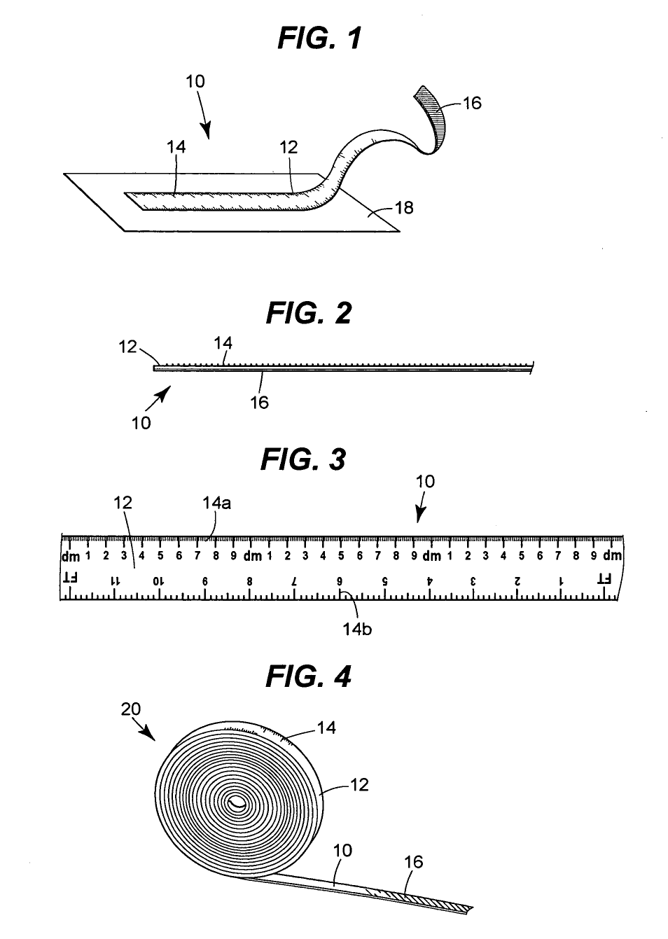

Referring now to FIGS. 1-3, a tape measure 10 is illustrated as including a thin, flat substrate 12 having one or more scales 14 (or scale components) printed on at least one side thereof and having an adhesive 16 disposed on the other side thereof. Of course, if desired, the adhesive 16 and the scales 14 may be located on the same side of the substrate 12. In the embodiment illustrated in FIG. 1, the tape measure 10 is shown as being partially disposed on a surface 18, with the adhesive 16 disposed between the surface 18 and the substrate 12.

As best illustrated in FIG. 1, the substrate 12 is preferably made of a flexible, but a relatively non-stretchable material, such as paper. In one embodiment, the substrate 12 is about an inch wide and may be formed of a low tack paper tape product manufactured and sold by the 3M company commercially identified as the Low Tack Paper Tape 3051 product. This particular product has a tensile strength of about 39 lbs./in. width (680 N/100 mm), a thickness of approximately 3.3 mils (0.08 mm) and an elongation at break of about two percent. Of course, other materials could be used for the substrate 12 instead, including any of a number of different materials, such as paper materials, plastic materials, etc. It is preferable that the substrate 12 be flexible enough to allow the substrate 12 to bend to match any desired surface contour, including right angles and other surface contours having small radiuses of curvature. However, as noted above, it is also desirable that the substrate 12 be made of a material that is non-stretchable or that has only a minimal ability to stretch. For example, it is preferable to use a material that is stretchable to only about five percent before breaking, and most preferable to use a material that is stretchable to about two percent or less before breaking. It is also desirable that the substrate 12 be made of a material that can be easily cut, torn, ripped (e.g., manually torn or ripped) and drilled through. It is also desirable that the substrate 12 be made of a material that accepts markings or writing in, for example, the form of pencil (graphite), pen (ink) and/or permanent marker. This ability to accept markings made from conventional pens, pencils and markers allows a user to make marks on the substrate 12 when the substrate 12 is affixed to a surface being measured, to denote specific locations at which, for example, to drill a hole, to place a nail or screw, to hang a picture, etc. without marking the surface on which the tape measure substrate 12 is disposed. Still further, the substrate 12 may be any desired color, or may be transparent or opaque to enable the user to see through the substrate 12 while, for example, writing on the substrate 12.

The adhesive 16 is preferably a semi-permanent or low tack adhesive that enables the substrate 12 to be removeably attached to a surface being measured. In one embodiment, the adhesive 16 may be a low tack acrylic adhesive, such as that provided on the 3051 Low Tack Paper Tape product manufactured and sold by the 3M company. This particular adhesive has an adhesion to steel of about 4 oz./in. width (4 N/100 mm), although adhesives having other adhesive strengths could be used instead. In any event, other adhesives may be used instead of or in addition to this adhesive. In one alternative embodiment, the adhesive 16 may be a permanent adhesive that allows the tape measure substrate 12 to be permanently affixed to a surface. While the adhesive 16 is illustrated in FIG. 1 as being disposed across and along the entire surface of one side of the substrate 12, the adhesive 16 could be disposed on only a portion of a side or surface of the substrate 12. Thus, the adhesive 16 could be placed on a side of the substrate 12 in one or more thin strips down the length of the substrate 12, in regularly spaced thin or thick strips across the width of the substrate 12, continuously or periodically along one or more edges of one side of the substrate 12, etc. Still further, while the, adhesive 16 is illustrated in FIGS. 1 and 2 as being disposed on one side of the substrate 12, the adhesive 16 could be disposed on both sides of the substrate 12 if so desired.

As more particularly illustrated in FIG. 3, the scale 14 may include a first scale component 14a and a second scale component 14b printed along different edges of one of the sides of the substrate 12. While not shown as such, the first and second scale components may instead be disposed or printed on opposite sides of the substrate 12. The scales 14a and 14b may indicate units in the same or different measurement system conventions, such as in the English or Metric conventions. In one embodiment, the scale components 14a and 14b may both indicate English units, such as inches, quarters of inches, eighths of inches, etc. to enable either edge of the tape measure 10 to be placed up on a wall or other surface, thereby making the tape measure 10 useable in any orientation. Alternatively, one of the scale components, such as the scale component 14a of FIG. 3, may indicate one type of measurement unit, such as Metric units of length, while the other of the scale components 14b indicates another type of measurement unit, such as English units of length. If the scale components 14a and 14b indicate the same types of units (such as English units), they may differ as to the smallest (and/or largest) unit marked. For example, one of the scale components 14a or 14b may mark every sixteenth inch, while the other of the scale components 14a or 14b may mark every quarter of an inch. Of course, any other unit of marking may be used on either or both of the scale components 14a and 14b. If desired, individual markings associated with any particular scale component 14a or 14b may be longer or shorter than the other markings of that scale component to assist a user in easily distinguishing different unit lengths, such as quarters of inches, half inches, inches, etc. Still further, the scales 14a and 14b may be oriented in opposite or reverse directions, as illustrated in FIG. 3, or in the same direction, if so desired.

If desired, the scale 14 may be printed directly onto the substrate 12 using any desired printing technique and any permanent or relatively permanent ink or other printing substance. Alternatively, the scale 14 may be applied to an additional piece of material, such as to a thin, transparent, plastic material, which may then be glued onto or otherwise affixed to one side of the substrate 12.

Unlike typical tape measure products, which generally have scales that mark lengths from a known end of the measuring tape and which therefore have a continuous and increasingly numbered scale in terms of inches, feet, etc. measured from that end, the scale 14 of the adhesive tape measure 10 may periodically repeat the numbering associated with certain ones of the units of length marked thereon but may refrain from numbering other ones of the units of length (typically larger units of length). For example, the markings on the scale 14 may label every foot with inches spanning from one to eleven (or twelve), but may refrain from marking the feet indications with numbers at all. This system is illustrated for the scale component 14b of FIG. 3. Similarly, the markings on the scale 14 may label every centimeter with numbers between one and nine (or ten), but not label the decimeter marks with specific decimeter numbers. This system is illustrated for the scale component 14a of FIG. 3. Thus, numbers related to some marks of the scale 14 may be present, while numbers related to other marks (e.g., associated with longer units) of the scale 14 may be intentionally left off. The reason for this numerical labeling feature is that the tape measure 10 is designed to be disposable of once used, and thus will not have a fixed end from which to start measuring. Instead, the user will need to select one of the markings, say a particular foot marking, as the beginning or starting point of the measuring process, and will need to count up from that location. This activity is facilitated by using a substrate 12 which enables the user to write or mark appropriate numbers of units on the face of the tape measure 10, such as to mark the first, second, third, etc. foot as such. However, it is desirable to facilitate measuring smaller units, such as units less than a foot, by marking the ¼, ½ and ¾ foot marks, the inches of each foot from one to twelve, etc., because requiring a user to manually count these smaller units may make use of the tape measure somewhat tedious. The trade-off is that, the longer the unit of measurement that is actually marked with numbers on the substrate 12, the more of the substrate 12 that must be used or disposed of in any given use to get to a periodic point on the tape measure 10 that starts over in the increasing numbering scheme. It is believed that a foot or a meter is an appropriate periodic length at which to stop numbering the units marked on the substrate 12. However, other units could be used as this periodic length including, for example, every centimeter, every 10 feet, every inch, etc.

As illustrated in FIG. 4, a single long piece or strip of the adhesive tape measure 10 may be rolled or formed into a tape roll 20 for ease of storage, sale and use. In this case, the single strip of the tape measure 10 within the roll 20 may be of any desired length and any portion of that strip may be spooled out from the tape roll 20 during use and may be cut, torn or ripped at any desired location. Here, the adhesive 16 on one side of the tape measure substrate 12 will adhere to the other side of the substrate 12 and cause the various layers of the roll 20 to stick together. If the adhesive 16 is a permanent adhesive, however, it may be desirable to place a protective layer of material, such as a waxed material, on the adhesive side of the substrate 12 before rolling the substrate 12 into the tape roll 20, to thereby allow the tape roll 20 to be unrolled. In this case, the protective layer of material may be removed from the adhesive side of the substrate 12 prior to placing the substrate 12 against the surface to which it is to be permanently adhered. Of course, such a protective layer of material may also be used when a non-permanent or low tack adhesive is used on the substrate 12. While FIG. 4 illustrates the tape roll 20 as being a stand-alone roll, the roll 20 may instead be disposed on a dispenser which has a feed and/or cutting mechanism, such as a dispenser typically associated with clear or transparent tape, like Scotch™ brand tape, packing tape, etc.

As will be understood, the tape measure 10 is useful in many different situations and environments. For example, the tape measure 10 may be used for direct marking activities when, for example, it is desirable to mark a location on a surface without leaving a mark on the surface itself. Such direct marking may include, for example, marking locations for drilling holes in a wall such as when hanging a picture or a shelf, when laying out borders, wallpaper, or trim in a room, etc. Likewise, the disposable tape measure 10 may be used to transfer items, such as when hanging mirrors or cabinets, by sticking the tape measure 10 to the back of the object, marking or piercing the tape measure substrate 12 at a desired location, and then aligning the same piece of tape measure substrate 12 on the wall or other surface on which the item is to be hung with, for example, a laser level. Still further, the tape measure 10 may be used to measure distances where a standard tape measure is impractical or difficult to use, such as when measuring a ceiling, measuring around corners, measuring along very long stretches, etc. The tape measure 10, once adhered to a surface, will follow any irregular shape, curve or even turn corners and will stay in place as long as user wants, thereby allowing multiple measurements without having to realign the tape measure 10. Thus, the tape measure 10 can be used to easily provide or lay a scale over curved surfaces, around corners, etc.

Of course, the tape measure 10 may be used to assist in room layouts, in recreational activities, such as in games, in school projects or activities to enhance learning, etc. Still further, the tape measure 10 may bemused instead of or as an addition to masking tape and packaging tape to illustrate or mark packing dimensions. Likewise, the tape measure 10 provides a surface on which to write or mark while measuring to prevent having to mark the wall, floor or other surface being measured. The tape measure 10 can also be cut or drilled through and makes layout easier for a single person because the tape measure 10 does not need to be held once it is affixed to a surface being measured.

Although certain tape measure configurations and constructions have been described herein in accordance with the teachings of the present disclosure, the scope of coverage of this patent is not limited thereto. On the contrary, this patent covers all embodiments of the teachings of the disclosure that fairly fall within the scope of permissible equivalents.

1. A tape measure comprising:
a flexible substrate that is non-stretchable;
an adhesive disposed on the flexible substrate; and
a scale having regularly spaced markings disposed on the flexible substrate,
wherein the flexible substrate is easily tearable at non-perforated and non-notched locations.

2. The tape measure of claim 1, wherein the adhesive comprises a semi-permanent adhesive.

3. The tape measure of claim 1, wherein the adhesive comprises a low tack adhesive.

4. The tape measure of claim 1, wherein the adhesive comprises a low tack acrylic adhesive.

5. The tape measure of claim 1, wherein the scale includes first and second scale components, wherein each of the first and second scale components includes a different set of markings to indicate various different units of lengths.

6. The tape measure of claim 5, wherein the first scale component is disposed at a first edge of a first side of the substrate and the second scale component is disposed at a second edge of the first side of the substrate.

7. The tape measure of claim 5, wherein the first scale component is visible at a first side of the substrate and the second scale component is visible at a second side of the substrate.

8. The tape measure of claim 5, wherein the first scale component includes markings spaced according to a first measurement system convention and the second scale component includes markings spaced according to a second measurement system convention.

9. The tape measure of claim 8, wherein the first measurement system convention is the English measurement system and the second measurement system convention is the Metric measurement system.

10. The tape measure of claim 5, wherein the first and second scale components include markings spaced according to a common measurement system convention.

11. The tape measure of claim 10, wherein the first scale component includes markings indicating a first smallest unit of measurement according to the common measurement system convention, the second scale component includes markings indicating a second smallest unit of measurement according to the common measurement system convention and wherein the first smallest unit of measurement is different than the second smallest unit of measurement.

12. The tape measure of claim 1, wherein the scale includes a plurality of markings indicating various different units of lengths.

13. The tape measure of claim 12, wherein the scale includes a first set of markings associated with a first unit of measurement labeled with increasing numbers indicating increasing ones of the first unit of measurement and includes a second set of markings associated with a second unit of measurement unlabeled with numbers indicating increasing ones of the second unit of measurement.

14. The tape measure of claim 13,.wherein the first unit of measurement comprises inches and the increasing numbers indicate different inches less than twelve, and wherein the second unit of measurement comprises feet.

15. The tape measure of claim 13, wherein the first unit of measurement comprises centimeters and the increasing numbers indicate different centimeters between one and ten, and wherein the second unit of measurement comprises decimeters or meters.

16. The tape measure of claim 1, wherein the substrate is flat.

17. The tape measure of claim 1, wherein the substrate is writable.

18. The tape measure of claim 1, wherein the substrate is transparent.

19. The tape measure of claim 1, wherein the substrate is opaque.

20. The tape measure of claim 1, wherein the substrate is made of paper.

21. The tape measure of claim 1, wherein the substrate is easily tearable.

22. A disposable tape measure device comprising:
a long flexible substrate that is non-stretchable and which can be torn manually at non-perforated and non-notched locations along the length of the substrate;
an adhesive disposed on the substrate; and
a scale having regularly spaced markings,.indicating locations on the substrate.

23. The disposable tape measure of claim 22, wherein the adhesive comprises a semi-permanent adhesive.

24. The disposable tape measure of claim 22, wherein the adhesive comprises a low tack adhesive.

25. The disposable tape measure of claim 22, wherein the substrate includes first and second sides and wherein the adhesive is disposed on the first side of the substrate and the scale is disposed on the second side of the substrate.

26. The disposable tape measure of claim 22, wherein the scale includes first and second scale components, wherein each of the first and second scale components includes a different set of markings to indicate various different units of lengths.

27. The disposable tape measure of claim 26, wherein the first scale component is disposed on a first edge of a first side of the substrate and the second scale component is disposed on a second edge of the first side of the substrate.

28. The disposable tape measure of claim 26, wherein the substrate includes a first side and a second side and the first scale component is disposed on the first side of the substrate and the second scale component is disposed on the second side of the substrate.

29. The disposable tape measure of claim 26, wherein the first scale component includes markings spaced according to a first measurement system convention and the second scale component includes markings spaced according to a second measurement system convention.

30. The disposable tape measure of claim 22, wherein the scale includes a plurality of markings indicating various different units of length.

31. The disposable tape measure of claim 30, wherein the scale includes a first set of markings associated with a first unit of measurement labeled with increasing numbers indicating increasing ones of the first unit of measurement and includes a second set of markings associated with a second unit of measurement unlabeled with numbers indicating increasing ones of the second unit of measurement.

32. The disposable tape measure of claim 31, wherein the first unit of measurement comprises inches and the increasing numbers indicate different inches less than twelve, and wherein the second unit of measurement comprises feet.

33. The disposable tape measure of claim 22, wherein the substrate is flat.

34. The disposable tape measure of claim 22, wherein the substrate is writable.

35. The disposable tape measure of claim 22, wherein the substrate is transparent.

36. The disposable tape measure of claim 22, wherein the substrate is opaque.

37. The disposable tape measure of claim 22, wherein the substrate is made of paper.

38. The tape measure of claim 1, wherein the flexible substrate is easily tearable at any point along the length of the flexible substrate.

39. The disposable tape measure of claim 22, wherein the flexible substrate can be torn manually at any point along the length of the substrate.

40. The disposable tape measure of claim 1, wherein the flexible substrate is a continuous piece of material along the length of the substrate.

41. The disposable tape measure of claim 1, wherein the flexible substrate includes a constant width along the length of the substrate.
